(19) United States
(12) Patent Application Publication
(10) Pub. No.: US 2025/0309495 A1
(43) Pub. Date: Oct. 2, 2025

(54) SECONDARY BATTERY

(71) Applicant: HONDA MOTOR CO., LTD., Tokyo (JP)

(72) Inventor: Toshiyuki ARIGA, Saitama (JP)

(21) Appl. No.: 19/058,028

(22) Filed: Feb. 20, 2025

(30) Foreign Application Priority Data
Mar. 30, 2024 (JP) 2024-058340

(51) Int. Cl. H01M 50/536; H01M 50/533; H01M 50/54

(52) U.S. Cl. CPC H01M 50/536; H01M 50/533; H01M 50/54

(57) ABSTRACT

In a secondary battery according to one embodiment of the present invention, the positive electrode tab lead includes a clamping portion that clamps the positive electrode current collector extension portion stack from both ends of the positive electrode current collector extension portion stack in the stacking direction. The negative electrode tab lead includes a clamping portion that clamps the negative electrode current collector extension portion stack from both ends of the negative electrode current collector extension portion stack in the stacking direction.

This application is based on and claims the benefit of priority from Japanese Patent Application No. 2024-058340, filed on 30 Mar. 2024, the content of which is incorporated herein by reference.

### BACKGROUND OF THE INVENTION

### Field of the Invention

The present invention relates to a secondary battery.

### Related Art

In recent years, research and development have been conducted on secondary batteries that contribute to energy efficiency, in order to enable more people to access affordable, reliable, sustainable, and advanced energy. As secondary batteries, a stacked secondary battery has been known that includes an electrode stack formed by alternately stacking a plurality of positive electrode layers and a plurality of negative electrode layers with a separator interposed therebetween. As an electrode extraction structure in stacked secondary batteries, a structure has been known that involves extending a portion of the current collector of each electrode layer to form current collector extension portions, stacking these extension portions, and connecting the resulting stack of current collector extension portions to a tab lead (see, for example, Patent Document 1).
Patent Document 1: Japanese Unexamined Patent Application, Publication No. 2022-110492

### SUMMARY OF THE INVENTION

In technologies related to secondary batteries, increasing capacity and enhancing long-term reliability remain significant challenges. Lithium metal secondary batteries are being investigated as high-capacity secondary batteries. These lithium metal secondary batteries utilize lithium ions as the charge transfer medium, in which lithium metal is deposited on the negative electrode layer during charging, and the lithium metal deposited on the negative electrode layer is transferred as lithium ions to the positive electrode layer during discharging.

Stacked lithium metal secondary batteries exhibit a significant change in thickness of the negative electrode layer during charging and discharging. Therefore, stacked lithium metal secondary batteries commonly use a laminated film as the housing that is expandable and contractible to accommodate changes in thickness of the negative electrode layer. When forming a housing with laminated film, the electrode stack is sandwiched between two sheets of laminated film, and the two sheets of laminated film are sealed together. In a lithium metal secondary battery of this structure, the tab leads are desirably arranged between the two sheets of laminated film, i.e., at the center of the electrode stack in the stacking direction. When the tab leads are arranged at the center of the electrode stack in the stacking direction, the position of the current collector extension portion stack deviates from the center of the electrode stack in the stacking direction.

When the position of the current collector extension portion stack deviates from the center of the electrode stack in the stacking direction, the difference in the lengths of the extension portions between the current collector closer to the stack and the current collector farther from the stack becomes significant. Particularly in lithium metal secondary batteries, the thickness of the negative electrode layer undergoes significant changes during charging and discharging, necessitating the lengthening of the extension portions for the current collectors located farther from the stack of the current collector extension portion. When the length of the current collector extension portions increases, the space required to accommodate the extension portions also needs to be increased, whereby the energy density of the secondary battery per unit volume decreases. Additionally, when the length of the current collector extension portions increases, the shape of the current collector extension portions becomes more susceptible to variations caused by changes in thickness of the negative electrode layer. This can lead to breakage at the joint between the current collector extension portions and the tab leads, thereby compromising the reliability of the electrical conduction pathway.

The present invention has been made in view of the above circumstances, and aims to provide a highly reliable secondary battery capable of increasing energy density per unit volume, even when using a negative electrode layer that exhibits significant changes in thickness during charging and discharging. Consequently, the present invention contributes to energy efficiency.

The inventors of the present invention have discovered that the objective can be achieved by arranging the current collector extension portion stack at the center of the electrode stack in the stacking direction and clamping the current collector extension portion stack from both ends by the tab leads in the stacking direction, whereby the current collector extension portion stack and the tab leads can be positioned at the center of the electrode stack in the stacking direction, thereby arriving at completion of the present invention. Thus, the present invention provides the following.
(1) A secondary battery, includes: an electrode stack in which a plurality of positive electrode layers and a plurality of negative electrode layers are alternately stacked with a separator interposed therebetween; a positive electrode tab lead; and a negative electrode tab lead, in which each of the plurality of positive electrode layers includes a positive electrode current collector and a positive electrode current collector extension portion extending from one side of the positive electrode current collector, ends of the plurality of positive electrode current collector extension portions extending from each of the plurality of positive electrode current collectors form a positive electrode current collector extension portion stack stacked at a center of the electrode stack in a stacking direction, the positive electrode tab lead includes a clamping portion that clamps the positive electrode current collector extension portion stack from both ends of the positive electrode current collector extension portion stack in the stacking direction, each of the plurality of negative electrode layers includes a negative electrode current collector and a negative electrode current collector extension portion extending from one side of the negative electrode current collector, ends of the plurality of negative each of the plurality of negative electrode current collectors form a negative electrode current collector extension portion stack stacked at the center of the electrode stack in the stacking direction, and the negative electrode tab lead includes a clamping portion that clamps the negative electrode current collector extension portion stack from both ends of the negative electrode current collector extension portion stack in the stacking direction.

According to the secondary battery as described in (1), the positive electrode current collector extension portion stack and the negative electrode current collector extension portion stack are arranged at the center of the electrode stack in the stacking direction, forming a structure symmetrical about the center of the electrode stack in the stacking direction. As a result, even with significant changes in thickness of the negative electrode layer during charging and discharging, the lengths of the positive electrode current collector extension portion and the negative electrode current collector extension portion do not need to be excessively extended. Therefore, the capacity per unit volume can be increased. The positive electrode current collector extension portion stack is clamped by the clamping portion of the positive electrode tab lead, and thus is less likely to detach from the positive electrode tab lead; likewise, and the negative electrode current collector extension portion stack is clamped by the clamping portion of the negative electrode tab lead, and thus is less likely to detach from the negative electrode tab lead. Consequently, the reliability is enhanced. Furthermore, the positive electrode tab lead and the negative electrode tab lead are arranged at the center of the electrode stack in the stacking direction, thereby facilitating the formation of the housing using a laminated film.
(2) In the secondary battery as described in (1), the clamping portion of the positive electrode tab lead includes a first bent portion that is bent toward one side of the positive electrode current collector extension portion stack in the stacking direction, and a second bent portion that is bent toward the other side thereof, and the electrode stack is clamped by the first bent portion and the second bent portion, and the clamping portion of the negative electrode tab lead includes a third bent portion that is bent toward one side of the positive electrode current collector extension portion stack in the stacking direction, and a fourth bent portion that is bent toward the other side thereof, and the negative electrode current collector extension portion stack is clamped by the third bent portion and the fourth bent portion.

According to the secondary battery as described in (2), the clamping portions of the positive electrode tab lead and the negative electrode tab lead are structured as described above, thereby allowing for securely clamping each of the positive electrode current collector extension portion stack and the negative electrode current collector extension portion stack.
(3) In the secondary battery as described in (2), the clamping portion of the positive electrode tab lead includes two or more of at least one among the first bent portion and the second bent portion, and the clamping portion of the negative electrode tab lead includes two or more of at least one among the third bent portion and the fourth bent portion.

According to the secondary battery as described in (3), the clamping portions of the positive electrode tab lead and the negative electrode tab lead are structured as described above, thereby allowing for robustly clamping each of the positive electrode current collector extension portion stack and the negative electrode current collector extension portion stack.
(4) In the secondary battery as described in (2) or (3), the first bent portion and the second bent portion of the positive electrode tab lead include opposing flat portions, respectively, and the positive electrode current collector extension portion stack is welded to the flat portions of the first bent portion and the flat portions of the second bent portion, the third bent portion and the fourth bent portion of the negative electrode tab lead include opposing flat portions, respectively, and the negative electrode current collector extension portion stack is welded to the flat portions of the third bent portion and the flat portions of the fourth bent portion.

According to the secondary battery as described in (4), the positive electrode tab lead and the negative electrode tab lead are structured as described above, thereby allowing for robustly clamping each of the positive electrode current collector extension portion stack and the negative electrode current collector extension portion stack.
(5) In the secondary battery as described in any one of (1) to (4), at least one of the positive electrode current collector and the negative electrode current collector is a stacked current collector formed by stacking a first metal layer, a resin layer, and a second metal layer in this order.

According to the secondary battery as described in (5), at least one of the positive electrode current collector and the negative electrode current collector is a stacked current collector. Thus, when the temperature of the secondary battery rises excessively, the resin layer in the stacked current collector melts, electrically isolating at least one of the positive electrode current collector and the positive electrode tab lead, and/or at least one of the negative electrode current collector and the negative electrode tab lead, thereby improving safety when temperature rises.
(6) In the secondary battery as described in (5), the positive electrode current collector is the stacked current collector, the ends of the plurality of positive electrode current collector extension portions are divided into a plurality of positive electrode current collector extension portion pieces by a slit formed along an extending direction of the positive electrode current collector extension portions, at least one of the plurality of positive electrode current collector extension portion pieces is folded with the first metal layer on the outside and the second metal layer on the inside, and the other one thereof is folded with the first metal layer on the inside and the second metal layer on the outside, the plurality of positive electrode current collector extension pieces folded with the first metal layer on the outside are stacked in mutual contact to form a first positive electrode current collector extension portion stack, and the plurality of positive electrode current collector extension portion pieces folded with the second metal layer on the outside are stacked in mutual contact to form a second positive electrode current collector extension portion stack, and the first positive electrode current collector extension portion stack and the second positive electrode current collector extension portion stack are clamped by the negative electrode tab lead.

According to the secondary battery as described in (6), the first metal layers of the positive electrode current collector are connected in the first positive electrode current collector extension portion stack, and the second metal layers of the positive electrode current collector are connected in the second positive electrode current collector extension portion stack, whereby the first metal layer and the second metal layer can be reliably electrically connected in the positive electrode current collector.
(7) In the secondary battery as described in (5) or (6), the negative electrode current collector is the stacked current collector, the ends of the plurality of negative electrode current collector extension portions are divided into a plurality of negative electrode current collector extension portion pieces by a slit formed along the extending direction of the negative electrode current collector extension portion, at least one of the negative electrode current collector extension portion pieces is folded with the first metal layer on the outside and the second metal layer on the inside, and one other thereof is folded with the first metal layer on the inside and the second metal layer on the outside, a plurality of the negative electrode current collector extension portion pieces folded with the first metal layer on the outside are stacked in mutual contact to form a first negative electrode current collector extension portion stack, and a plurality of the negative electrode current collector extension portion pieces folded with the second metal layer on the outside are stacked in mutual contact to form a second negative electrode current collector extension portion stack, and the first negative electrode current collector extension portion stack and the second negative electrode current collector extension portion stack are clamped by the negative electrode tab lead.

According to the secondary battery as described in (7), the first metal layers of the negative electrode current collector are connected in the first negative electrode current collector extension portion stack, and the second metal layers of the negative electrode current collector are connected in the second negative electrode current collector extension portion stack, whereby the first metal layer and the second metal layer can be reliably electrically connected in the negative electrode current collector.

The present invention makes it possible to provide a highly reliable secondary battery capable of increasing energy density per unit volume, even when using a negative electrode layer that exhibits significant changes in thickness during charging and discharging.

### BRIEF DESCRIPTION OF THE DRAWINGS

FIG. 1 is a cross-sectional view of a secondary battery according to a first embodiment of the present invention;

FIG. 2 is a plan view of the secondary battery illustrated in FIG. 1 from which the housing has been omitted from illustration;

FIG. 3 is a cross-sectional view along the line III-III in FIG. 2;

FIG. 4 is a perspective view of a positive electrode tab lead used in the secondary battery illustrated in FIG. 1;

FIG. 5 is a plan view of the secondary battery on the positive electrode tab lead side according to the second embodiment of the present invention, from which the housing has been omitted from illustration;

FIG. 6 is a cross-sectional view along the line VI-VI in FIG. 5;

FIG. 7 is a cross-sectional view along the line VII-VII in FIG. 5;

FIG. 8 is an exploded perspective view of the secondary battery on the positive electrode tab lead side illustrated in FIG. 5; and

FIG. 9 is a perspective view of an example of the positive electrode tab lead that can be used in the present invention.

### DETAILED DESCRIPTION OF THE INVENTION

Hereinafter, embodiments of the present invention will be described with reference to the drawings. However, the embodiments described below are merely illustrative and do not limit the scope of the present invention.

### First Embodiment

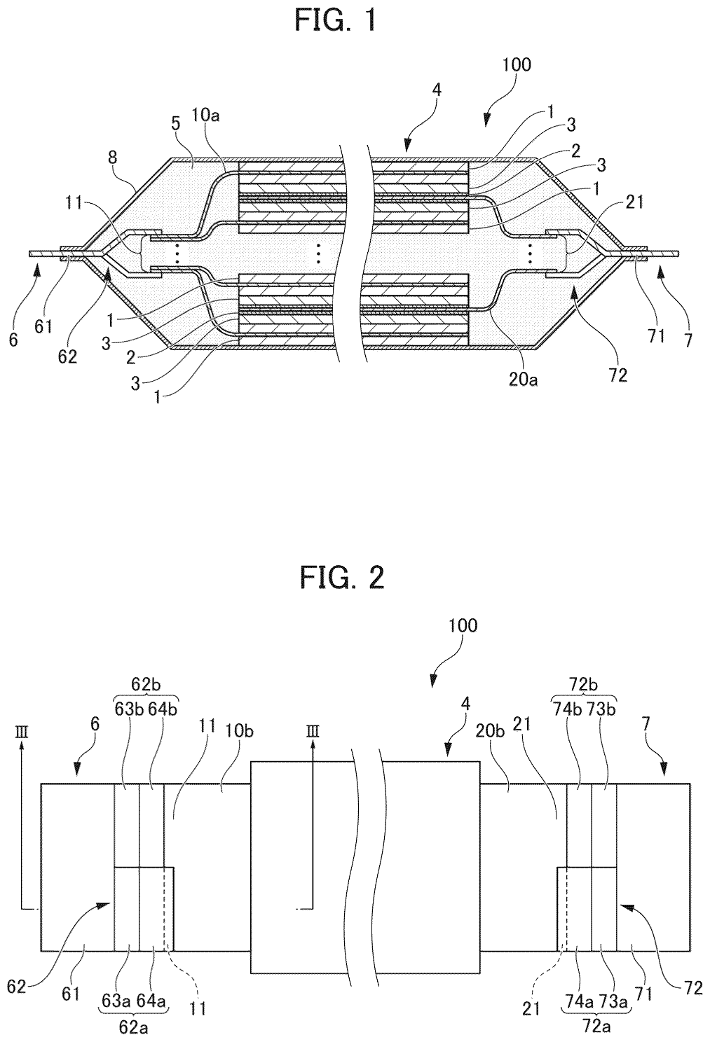

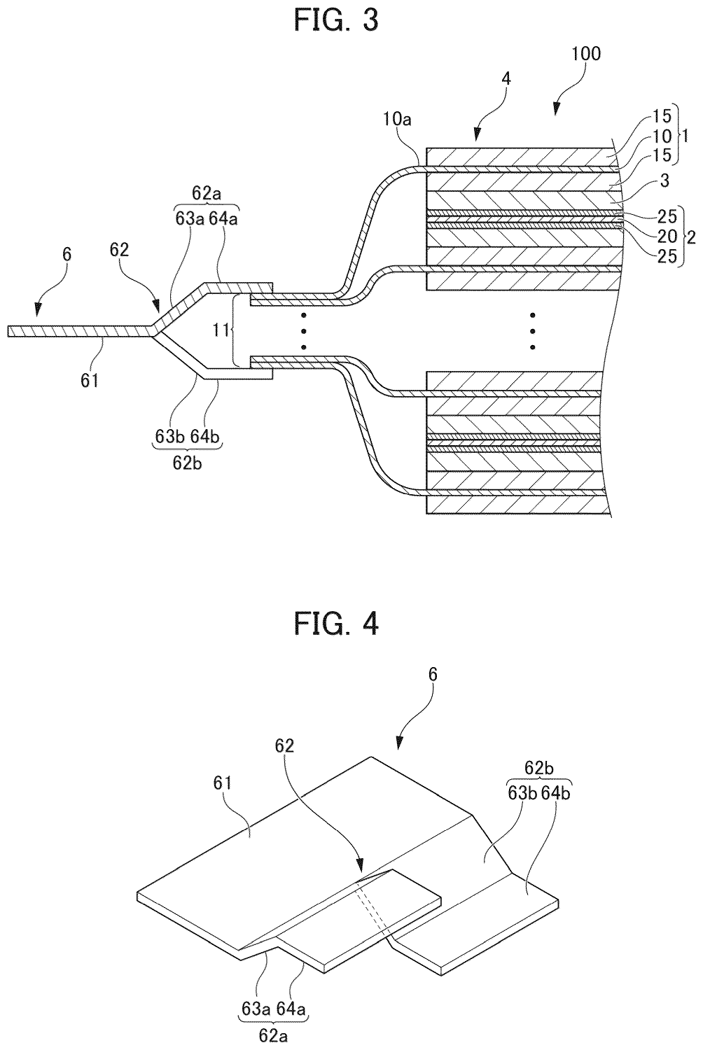

FIG. 1 is a cross-sectional view of a secondary battery according to a first embodiment of the present invention. FIG. 2 is a plan view of the secondary battery illustrated in FIG. 1 from which the housing has been omitted from illustration; FIG. 3 is a cross-sectional view along the line III-III in FIG. 2; and FIG. 4 is a perspective view of the positive electrode tab lead used in the secondary battery illustrated in FIG. 1.

A secondary battery 100 of the first embodiment includes an electrode stack 4, an electrolytic solution 5, a positive electrode tab lead 6, a negative electrode tab lead 7, and a housing 8. The electrode stack 4 is a stack, in which a plurality of positive electrode layers 1 and a plurality of negative electrode layers 2 are alternately stacked with a separator 3 interposed therebetween. A positive electrode tab lead 6 and a negative electrode tab lead 7 are arranged at opposing positions with the electrode stack 4 interposed therebetween.

The positive electrode layer 1 includes a positive electrode current collector 10 and a positive electrode active material layer 15. The positive electrode active material layer 15 is stacked on both surfaces of the positive electrode current collector 10. Each positive electrode current collector 10 in the plurality of positive electrode layers 1 includes a positive electrode current collector extension portion 10a extending toward the positive electrode tab lead 6 side. The end portions of each positive electrode current collector extension portion 10a are stacked at the center of the electrode stack 4 in the stacking direction to form a positive electrode current collector extension portion stack 11. The center of the electrode stack 4 in the stacking direction is not necessarily the exact center point, but may include a range from the midpoint to one-tenth of the length of the electrode stack 4 in the stacking direction.

The positive electrode tab lead 6 includes a base portion 61 and a clamping portion 62. Part of the base portion 61 is exposed from the housing 8. The positive electrode tab lead 6 is arranged at the center of the electrode stack 4 in the stacking direction. The clamping portion 62 includes a first bent portion 62a that is bent toward one side (upper side in FIG. 4) of the positive electrode current collector extension portion stack 11 in the stacking direction, and a second bent portion 62b that is bent toward the opposite side (lower side in FIG. 4). The first bent portion 62a includes a first sloped portion 63a with one end connected to the base portion 61 and the other end extending upward diagonally, and a first flat portion 64a connected to the other end of the first sloped portion 63a. The second bent portion 62b includes a second sloped portion 63b with one end connected to the base portion 61 and the other end extending downward diagonally, and a second flat portion 64b connected to the other end of the second sloped portion 63b. The first flat portion 64a and the second flat portion 64b are orthogonal to the stacking direction of the positive electrode current collector extension portion stack 11. The positive electrode current collector extension portion stack 11 is clamped by the first flat portion 64a and the second flat portion 64b. The first flat portion 64a and the second flat portion 64b make surface contact with the positive electrode current collector extension portion stack 11, thereby allowing the positive electrode tab lead 6 to clamp the positive electrode current collector extension portion stack 11 more firmly. The respective positive electrode current collector extension portions 10a of the positive electrode current collector extension portion stack 11, the positive electrode current collector extension portion stack 11 and the first flat portion 64a, and the positive electrode current collector extension portion stack 11 and the second flat portion 64b are welded together. The welding method that can be used include, for example, resistance welding or ultrasonic welding.

The negative electrode layer 2 includes a negative electrode current collector 20 and a lithium metal-containing layer 25. The lithium metal-containing layer 25 is stacked on both surfaces of the negative electrode current collector 20. Each negative electrode current collector 20 in the plurality of negative electrode layers 2 includes a negative electrode current collector extension portion 20a extending toward the negative electrode tab lead 7 side. The end portions of each negative electrode current collector extension portion 20a are stacked at the center of the electrode stack 4 in the stacking direction to form a negative electrode current collector extension portion stack 21.

The negative electrode tab lead 7 includes a base portion 71 and a clamping portion 72. The negative electrode tab lead 7 is arranged at the center of the electrode stack 4 in the stacking direction. The clamping portion 72 includes a third bent portion 72a that is bent toward one side of the negative electrode current collector extension portion stack 21 in the stacking direction, and a fourth bent portion 72b that is bent toward the opposite side. The third bent portion 72a includes a third sloped portion 73a with one end connected to the base portion 71 and the other end extending upward diagonally, and a third flat portion 74a connected to the other end of the third sloped portion 73a. The fourth bent portion 72b includes a fourth sloped portion 73b with one end connected to the base portion 71 and the other end extending downward diagonally, and a fourth flat portion 74b connected to the other end of the fourth sloped portion 73b. The third flat portion 74a and the fourth flat portion 74b are orthogonal to the stacking direction of the negative electrode current collector extension portion stack 21. The negative electrode current collector extension portion stack 21 is clamped by the third flat portion 74a and the fourth flat portion 74b. The third flat portion 74a and the fourth flat portion 74b make surface contact with the negative electrode current collector extension portion stack 21, thereby allowing the negative electrode tab lead 7 to clamp the negative electrode current collector extension portion stack 21 more firmly. The respective negative electrode current collector extension portions 20a of the negative electrode current collector extension portion stack 21, the negative electrode current collector extension portion stack 21 and the third flat portion 74a, and the negative electrode current collector extension portion stack 21 and the fourth flat portion 74b are welded together. The welding methods that can be used include, for example, resistance welding and ultrasonic welding.

The secondary battery 100 of the present embodiment is a lithium metal secondary battery using lithium ions as the charge transfer medium, in which lithium metal deposits on the surface of the lithium metal-containing layer 25 of the negative electrode layer 2 during charging, and the lithium metal migrates as lithium ions to the positive electrode active material layer 15 of the positive electrode layer 1 during discharging. The materials for each component of the secondary battery 100 are as follows.

Examples of materials for the positive electrode current collector 10 include aluminum, aluminum alloy, stainless steel, nickel, iron, and titanium.

The positive electrode active material layer 15 contains a positive electrode active material. Examples of positive electrode active materials include layered active materials containing lithium, spinel-type active materials, and olivine-type active materials. Specific examples of positive electrode active materials include lithium cobalt oxide (LiCoO₂), lithium nickel oxide (LiNiO₂), LiNiₚMn_{q}CoᵣO₂ (where p+q+r=1), LiNiₚAl_{q}CoᵣO₂ (where p+q+r=1), lithium manganese oxide (LiMn₂O₄), heteroelement-substituted Li—Mn spinel such as Li₁₊ₓMn_{2-x-y}MO₄ (where x+y=2, and M is at least one element selected from Al, Mg, Co, Fe, Ni, and Zn), lithium titanate (an oxide containing Li and Ti), and lithium metal phosphate (LIMPO₄, where M is at least one element selected from Fe, Mn, Co, and Ni). The positive electrode active material layer 15 may further include conductive additives and binders.

Examples of materials for the negative electrode current collector 20 include nickel, copper, and stainless steel.

The lithium metal-containing layer 25 includes either lithium, or a metal that forms an alloy with lithium, or both. Examples of metals that form alloys with lithium include Mg, Si, Au, Ag, In, Ge, Sn, Pb, Al, and Zn.

The separator 3 is not particularly limited and may, for example, be a porous sheet or nonwoven fabric sheet commonly used as a separator in lithium metal secondary batteries. Examples of materials for porous sheets include polyolefins such as polyethylene and polypropylene, aramid, polyimide, and fluororesin. Examples of materials for nonwoven sheets include glass fiber and cellulose fiber.

The electrolytic solution 5 includes an organic solvent and an electrolyte. Examples of organic solvents include cyclic carbonates, chain carbonates, cyclic ethers, chain ethers, hydrofluoroethers, aromatic ethers, sulfones, cyclic esters, chain carboxylic acid esters, and nitriles. Examples of cyclic carbonates include ethylene carbonate, propylene carbonate, vinylene carbonate, and fluoroethylene carbonate. Examples of chain carbonates include dimethyl carbonate, diethyl carbonate, and ethyl methyl carbonate. Examples of cyclic ethers include tetrahydrofuran, 2-methyltetrahydrofuran, tetrahydropyran, 1,3-dioxolane, and 4-methyl-1,3-dioxolane. Examples of chain ethers include 1,2-dimethoxyethane, 1,2-diethoxyethane, ethoxymethoxyethane, and diethyl ether. Examples of hydrofluoroethers include 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl) ether, and 1,2-bis(1,1,2,2-tetrafluoroethoxy) ethane. An example of an aromatic ether is anisole. Examples of sulfones include sulfolane and methyl sulfolane. An example of a cyclic ester is γ-butyrolactone. Examples of chain carboxylic acid esters include acetic acid ester, butyric acid ester, and propionic acid ester. Examples of nitriles include acetonitrile and propionitrile. A single type of organic solvent may be used alone or in combination with two or more types.

The electrolyte, as a source of lithium ions serving as a charge transfer medium, includes lithium salts. Examples of lithium salts include LiPF₆, LiBF₄, LiClO₄, LiAsF₆, LiCF₃SO₃, LiC(CF₃SO₂)₃, LiN(CF₃SO₂)₂(LiTFSI), LiN(FSO₂)₂(LiFSI), and LiBC₄O₈. A single type of lithium salt may be used alone or in combination with two or more types. The concentration of the electrolyte is, for example, within the range of 1.5 to 4.0 mol/L.

Examples of materials for the positive electrode tab lead 6 and the negative electrode tab lead 7 include copper, copper alloy, aluminum, aluminum alloy, stainless steel, nickel, iron, and titanium.

The housing 8 is designed to be expandable and contractible to accommodate changes in thickness of the negative electrode layer 2 during charging and discharging. Examples of materials that can be used for the housing 8 include a laminated film. A layered film with a three-layer structure may be used as the laminated film, in which an inner resin layer, a metal layer, and an outer resin layer are laminated in this order from the inner side. For example, the outer resin layer may be a polyamide (nylon) layer or polyethylene terephthalate (PET) layer, the metal layer may be an aluminum layer, and the inner resin layer may be a polyethylene or polypropylene layer.

The secondary battery 100 can be manufactured, for example, as follows. The positive electrode layers 1 and the negative electrode layers 2 are alternately stacked with the separator 3 interposed therebetween to obtain the electrode stack 4. Next, the ends of the positive electrode current collector extension portions 10a of each positive electrode layer 1 are stacked to form a positive electrode current collector extension portion stack 11. Subsequently, the positive electrode current collector extension portion stack 11 is inserted between the first bent portion 62a and the second bent portion 62b of the positive electrode tab lead 6; the upper planar surface of the positive electrode current collector extension portion stack 11 is joined to the first flat portion 64a, and the lower planar surface thereof is joined to the second flat portion 64b. Thus, the positive electrode current collector extension portion stack 11 is clamped by the clamping portion 62 of the positive electrode tab lead 6. In a similar manner, the negative electrode current collector extension portion stack 21 is clamped by the clamping portion 72 of the negative electrode tab lead 7. Next, the electrode stack 4 is sandwiched between laminated films, three sides of the laminated film are sealed to form a pouch, and the electrolytic solution 5 is injected. Then, the remaining side of the laminated film is sealed to form the housing 8.

According to the secondary battery 100 of the first embodiment, configured as described above, the positive electrode current collector extension portion stack 11 and the negative electrode current collector extension portion stack 21 are arranged at the center of the electrode stack 4 in the stacking direction, and are symmetrically structured about the center of the electrode stack 4 in the stacking direction. Therefore, even with significant changes in thickness of the negative electrode layer 2 during charging and discharging, the lengths of the positive electrode current collector extension portion 10a and the negative electrode current collector extension portion 20a do not need to be excessively extended. As a result, the capacity per unit volume can be increased. The positive electrode current collector extension portion stack 11 is clamped by the clamping portion 62 of the positive electrode tab lead 6, and is, therefore, less likely to detach from the positive electrode tab lead 6. Similarly, the negative electrode current collector extension portion stack 21 is clamped by the clamping portion 72 of the negative electrode tab lead 7, and is, therefore, less likely to detach from the negative electrode tab lead 7. Consequently, reliability is improved. Furthermore, the positive electrode tab lead 6 and the negative electrode tab lead 7 are arranged at the center of the electrode stack 4 in the stacking direction, thereby facilitating the formation of the housing 8 using a laminated film.

### Second Embodiment

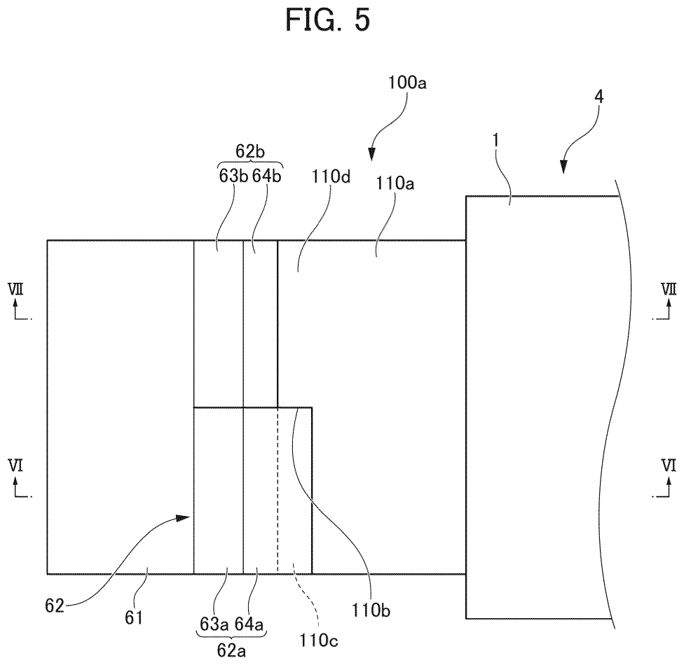

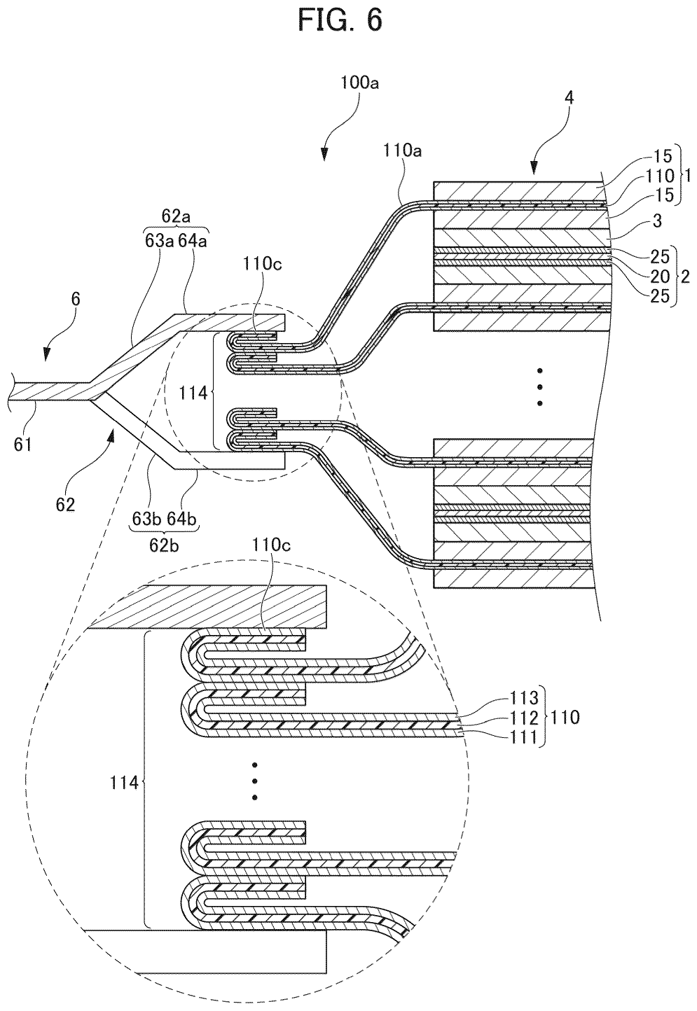

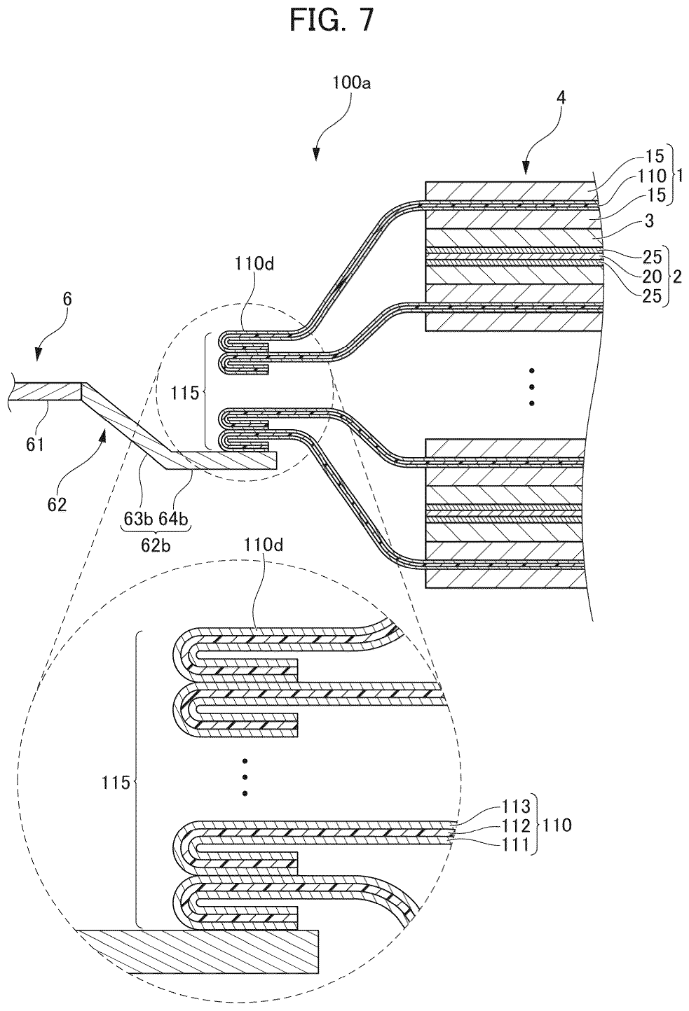

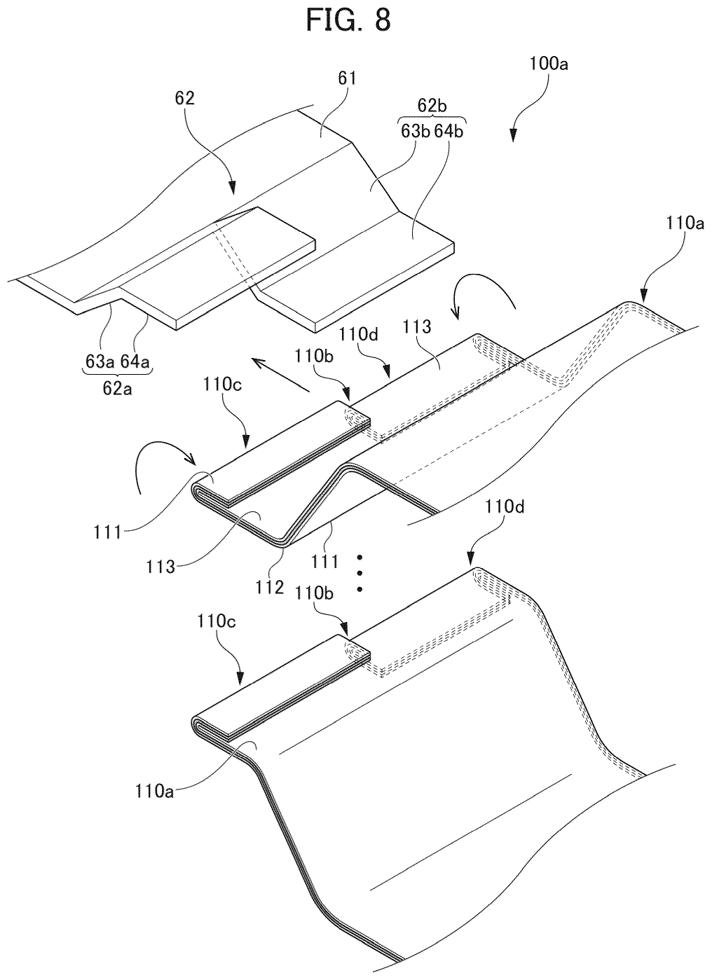

FIG. 5 is a plan view of the secondary battery on the positive electrode tab lead side according to the second embodiment of the present invention, from which the housing has been omitted from illustration. FIG. 6 is a cross-sectional view along the line VI-VI in FIG. 5, and FIG. 7 is a cross-sectional view along the line VII-VII in FIG. 5. FIG. 8 is an exploded perspective view of the secondary battery on the positive electrode tab lead side illustrated in FIG. 5.

In the secondary battery 100a of the present embodiment, the positive electrode current collector 110 is configured as a stacked current collector, in which a first metal layer 111, a resin layer 112, and a second metal layer 113 are stacked in this order. The other configurations are the same as those of the secondary battery 100 of the first embodiment, and thus the same reference numbers are assigned to the same components, and descriptions thereof are omitted.

The positive electrode layer 1 includes a positive electrode current collector 110 and a positive electrode active material layer 15. The positive electrode active material layer 15 is laminated on both surfaces of the positive electrode current collector 110. Each positive electrode current collector 110 of the plurality of positive electrode layers 1 includes a positive electrode current collector extension portion 110a extending towards the positive electrode tab lead 6 side.

The end of each positive electrode current collector extension portion 110a is divided by a slit 110b, which is formed along the extending direction of the positive electrode current collector extension portion 110a, into two pieces: a first positive electrode current collector extension portion piece 110c and a second positive electrode current collector extension portion piece 110d. The first positive electrode current collector extension portion piece 110c is folded with the first metal layer 111 on the outside and the second metal layer 113 on the inside. The second positive electrode current collector extension portion piece 110d is folded with the first metal layer 111 on the inside and the second metal layer 113 on the outside.

As illustrated in FIG. 6, the first positive electrode current collector extension portion pieces 110c of each positive electrode current collector extension portion 110a are stacked to form a first positive electrode current collector extension portion stack 114. The first positive electrode current collector extension portion stack 114 is arranged at the center of the electrode stack 4 in the stacking direction. The first positive electrode current collector extension portion stack 114 is connected to the first flat portion 64a of the first bent portion 62a of the positive electrode tab lead 6. The respective first positive electrode current collector extension portion pieces 110c of the first positive electrode current collector extension portion stack 114 are welded, as well as the first positive electrode current collector extension portion stack 114 being welded to the first flat portion 64a. The welding method may be, for example, resistance welding or ultrasonic welding, with resistance welding being preferred. By using resistance welding, each first positive electrode current collector extension portion piece 110c can be welded without partially degrading the resin layer 112 of the positive electrode current collector 110.

As illustrated in FIG. 7, the second positive electrode current collector extension portion pieces 110d of each positive electrode current collector extension portion 110a are stacked to form a second positive electrode current collector extension portion stack 115. The second positive electrode current collector extension portion stack 115 is arranged at the center of the electrode stack 4 in the stacking direction. The second positive electrode current collector extension portion stack 115 is connected to the second flat portion 64b of the second bent portion 62b of the positive electrode tab lead 6. The respective second positive electrode current collector extension portion pieces 110d of the second positive electrode current collector extension portion stack 115 are welded, as well as the connection between the second positive electrode current collector extension portion stack 115 being welded to the second flat portion 64b. The welding method may be, for example, resistance welding or ultrasonic welding, with resistance welding being preferred.

In the secondary battery 100a of the present embodiment, the first metal layer 111 of each positive electrode layer 1 is electrically connected by the first positive electrode current collector extension portion stack 114, and the second metal layer 113 of each positive electrode layer 1 is electrically connected by the second positive electrode current collector extension portion stack 115. The first positive electrode current collector extension portion stack 114 and the second positive electrode current collector extension portion stack 115 are clamped by the clamping portion 62 of the positive electrode tab lead 6, thereby electrically connecting the first metal layer 111 and the second metal layer 113 of each positive electrode layer 1.

Materials similar to those used for the positive electrode current collector 10 of the secondary battery 100 of the first embodiment can be used as materials for the first metal layer 111 and the second metal layer 113 of the positive electrode current collector 110. Examples of materials for the resin layer 112 include thermoplastic resins such as polyethylene terephthalate (PET) and polypropylene (PP).

According to the secondary battery 100a of the present embodiment, the first positive electrode current collector extension portion stack 114 and the second positive electrode current collector extension portion stack 115 are arranged at the center of the electrode stack 4 in the stacking direction, the first positive electrode current collector extension portion stack 114 and the second positive electrode current collector extension portion stack 115 are clamped by the clamping portion 62 of the positive electrode tab lead 6, and the positive electrode tab lead 6 is arranged at the center of the electrode stack in the stacking direction. Therefore, the same effects as those of the secondary battery 100 of the first embodiment can be achieved. Furthermore, according to the secondary battery 100a of the present embodiment, the positive electrode current collector 110 is configured as a stacked current collector including the resin layer 112. Therefore, when the temperature of the secondary battery becomes excessively high, the resin layer 112 melts, thereby electrically isolating the positive electrode current collector 110 from the positive electrode tab lead 6. This enhances safety when the temperature rises. The first metal layers 111 of the positive electrode current collector 110 are connected in the first positive electrode current collector extension portion stack 114, and the second metal layers 113 of the positive electrode current collector 110 are connected in the second positive electrode current collector extension portion stack 115, whereby the first metal layer 111 and the second metal layer 113 can be reliably electrically connected in the positive electrode current collector 110.

In the present embodiment, the secondary battery 100a configures the positive electrode current collector 110 as a stacked current collector. The negative electrode current collector may also be configured as a stacked current collector, or both of the positive electrode current collector and the negative electrode current collector may be configured as stacked current collectors.

The positive electrode tab lead 6 used in the present embodiment is configured with the clamping portion 62 that includes a single first bent portion 62a and a single second bent portion 62b; however, the number of bent portions is not limited. The same applies to the negative electrode tab lead 7.

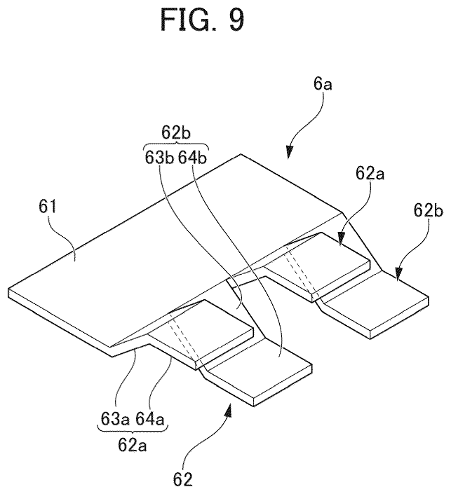

FIG. 9 is a perspective view of an example of a positive electrode tab lead that can be used in the present invention. The positive electrode tab lead 6a illustrated in FIG. 9 includes two first bent portions 62a and two second bent portions 62b, which are alternately arranged.

In the present embodiment, the clamping portion 62 of the positive electrode tab lead 6 includes flat portions (the first flat portion 64a and the second flat portion 64b), and the flat portions make surface contact with the positive electrode current collector extension portions 10a and 110a. However, the contact method between the clamping portion 62 and the positive electrode current collector extension portions 10a and 110a is not limited. The clamping portion 62 of the positive electrode tab lead 6 may not include flat portions, and instead, the clamping portion 62 may make point contact with the positive electrode current collector extension portions 10a and 110a. The same applies to the negative electrode tab lead 7.

In the present embodiment, the secondary batteries 100 and 100a are lithium metal secondary batteries with a non-aqueous solvent containing the electrolytic solution 5; however, the secondary batteries of the present invention are not limited to this configuration. For example, the secondary battery of the present invention may be an all-solid-state lithium metal secondary battery using a solid electrolyte.

In the second embodiment, the end of the positive electrode current collector extension portion 110a is divided by the slit 110b into the two pieces of the first positive electrode current collector extension portion piece 110c and the second positive electrode current collector extension portion piece 110d; however, the positive electrode current collector extension portion 110a may be divided into three or more pieces. Alternatively, without dividing the positive electrode current collector extension portion 110a, the end portions of the positive electrode current collector extension portion 110a may be stacked, and the stacked resin layer 112 of the positive electrode current collector extension portion 110a may be partially melted to electrically connect the first metal layer 111 and the second metal layer 113.

The secondary batteries 100 and 100a are lithium metal secondary batteries with a non-aqueous electrolyte solvent containing the electrolytic solution 5; however, the secondary battery of the present invention is not limited to this configuration. For example, the secondary battery of the present invention may be an all-solid-state lithium metal secondary battery prepared using a solid electrolyte.

### EXPLANATION OF REFERENCE NUMERALS

1: positive electrode layer
2: negative electrode layer
3: separator
4: electrode stack
5: electrolytic solution
6, 6a: positive electrode tab lead
8: housing
10: positive electrode current collector
10a: positive electrode current collector extension portion
11: positive electrode current collector extension portion stack
12: negative electrode current collector extension portion stack
15: positive electrode active material layer
20: negative electrode current collector
20a: negative electrode current collector extension portion
21: negative electrode current collector extension portion stack
25: lithium metal-containing layer
61: base portion
62: clamping portion
62a: first bent portion
62b: second bent portion
63a: first sloped portion
63b: second sloped portion
64a: first flat portion
64b: second flat portion
71: base portion
72: clamping portion
72a: third bent portion
72b: fourth bent portion
73a: third sloped portion
73b: fourth sloped portion
74a: third flat portion
74b: fourth flat portion
100, 100a: secondary battery
110: positive electrode current collector
110a: positive electrode current collector extension portion
110b: slit
110c: first positive electrode current collector extension portion piece
110d: second positive electrode current collector extension portion piece
111: first metal layer
112: resin layer
113: second metal layer
114: first positive electrode current collector extension portion stack
115: second positive electrode current collector extension portion stack

What is claimed is:

1. A secondary battery, comprising:
an electrode stack in which a plurality of positive electrode layers and a plurality of negative electrode layers are alternately stacked with a separator interposed therebetween;
a positive electrode tab lead; and
a negative electrode tab lead, wherein
each of the plurality of positive electrode layers includes a positive electrode current collector and a positive electrode current collector extension portion extending from one side of the positive electrode current collector,
ends of the plurality of positive electrode current collector extension portions extending from each of the plurality of positive electrode current collectors form a positive electrode current collector extension portion stack stacked at a center of the electrode stack in a stacking direction,
the positive electrode tab lead includes a clamping portion that clamps the positive electrode current collector extension portion stack from both ends of the positive electrode current collector extension portion stack in the stacking direction,
each of the plurality of negative electrode layers includes a negative electrode current collector and a negative electrode current collector extension portion extending from one side of the negative electrode current collector,
ends of the plurality of negative electrode current collector extension portion extending from each of the plurality of negative electrode current collectors form a negative electrode current collector extension portion stack stacked at the center of the electrode stack in the stacking direction, and
the negative electrode tab lead includes a clamping portion that clamps the negative electrode current collector extension portion stack from both ends of the negative electrode current collector extension portion stack in the stacking direction.

2. The secondary battery according to claim 1, wherein
the clamping portion of the positive electrode tab lead includes a first bent portion that is bent toward one side of the positive electrode current collector extension portion stack in the stacking direction, and a second bent portion that is bent toward one other side thereof, and the electrode stack is clamped by the first bent portion and the second bent portion, and
the clamping portion of the negative electrode tab lead includes a third bent portion that is bent toward one side of the positive electrode current collector extension portion stack in the stacking direction, and a fourth bent portion that is bent toward one other side thereof, and the negative electrode current collector extension portion stack is clamped by the third bent portion and the fourth bent portion.

3. The secondary battery according to claim 2, wherein
the clamping portion of the positive electrode tab lead includes two or more of at least one among the first bent portion and the second bent portion, and
the clamping portion of the negative electrode tab lead includes two or more of at least one among the third bent portion and the fourth bent portion.

4. The secondary battery according to claim 2, wherein
the first bent portion and the second bent portion of the positive electrode tab lead include opposing flat portions, respectively, and the positive electrode current collector extension portion stack is welded to the flat portions of the first bent portion and the flat portions of the second bent portion,
the third bent portion and the fourth bent portion of the negative electrode tab lead include opposing flat portions, respectively, and the negative electrode current collector extension portion stack is welded to the flat portions of the third bent portion and the flat portions of the fourth bent portion.

5. The secondary battery according to claim 1, wherein at least one among the positive electrode current collector and the negative electrode current collector is a stacked current collector formed by stacking a first metal layer, a resin layer, and a second metal layer in this order.

6. The secondary battery according to claim 5, wherein
the positive electrode current collector is the stacked current collector,
the ends of the plurality of positive electrode current collector extension portions are divided into a plurality of positive electrode current collector extension portion pieces by a slit formed along an extending direction of the positive electrode current collector extension portion, at least one of the plurality of positive electrode current collector extension portion pieces is folded with the first metal layer on an outside and the second metal layer on an inside, and one other thereof is folded with the first metal layer on the inside and the second metal layer on the outside,
the plurality of positive electrode current collector extension pieces folded with the first metal layer on the outside are stacked in mutual contact to form a first positive electrode current collector extension portion stack, and the plurality of positive electrode current collector extension portion pieces folded with the second metal layer on the outside are stacked in mutual contact to form a second positive electrode current collector extension portion stack, and
the first positive electrode current collector extension portion stack and the second positive electrode current collector extension portion stack are clamped by the negative electrode tab lead.

7. The secondary battery according to claim 5, wherein
the negative electrode current collector is the stacked current collector,
the ends of the plurality of negative electrode current collector extension portions are divided into a plurality of negative electrode current collector extension portion pieces by a slit formed along the extending direction of the negative electrode current collector extension portion, at least one of the negative electrode current collector extension portion pieces is folded with the first metal layer on the outside and the second metal layer on the inside, and one other thereof is folded with the first metal layer on the inside and the second metal layer on the outside,
a plurality of the negative electrode current collector extension portion pieces folded with the first metal layer on the outside are stacked in mutual contact to form a first negative electrode current collector extension portion stack, and a plurality of the negative electrode current collector extension portion pieces folded with the second metal layer on the outside are stacked in mutual contact to form a second negative electrode current collector extension portion stack, and
the first negative electrode current collector extension portion stack and the second negative electrode current collector extension portion stack are clamped by the negative electrode tab lead.
